(19) United States
(12) Patent Application Publication
(10) Pub. No.: US 2010/0053440 A1
(43) Pub. Date: Mar. 4, 2010

(54) TELEVISION FAST POWER UP MODE

(76) Inventor: Peter Mortensen, Lake Elsinore, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/548,606

(22) Filed: Aug. 27, 2009

Related U.S. Application Data
(60) Provisional application No. 61/093,360, filed on Sep. 1, 2008.

(51) Int. Cl. H04N 5/50; H04N 5/63

(52) U.S. Cl. 348/569; 348/730; 348/E05.097; 348/E05.127

(57) ABSTRACT

Systems and methods that facilitates in a television a fast transition from a off/low power state to powered up/operating state. In a preferred embodiment, the television comprises a screen, a projection/image display engine coupled to the screen, an on-screen-display (OSD) controller coupled to the display engine, and a digital module (control module) coupled to the OSD controller. The control module preferably comprises a processor configured with a low power mode of operation and adapted to maintain the television operating parameters while in the low power mode of operation.

### CROSS-REFERENCE TO RELATED APPLICATION

This application claims the benefit of provisional application Ser. No. 61/093,360 filed Sep. 1, 2008, which is fully incorporated herein by reference.

### FIELD

The present invention relates generally to televisions and, more particularly, to systems and methods that facilitate a fast transition from an off/low power state to powered up/operating state.

### BACKGROUND

As television features continue to expand and improve requiring larger and slower to startup software applications to run on the television micro processor, one area of consumer dissatisfaction is the time it takes to power up a television to begin viewing a program. In some instances, the delay between the consumer pressing the button and being able to begin viewing a program is quite substantial. This delay is increased along with consumer frustration if the TV has just been turned off by pressing the power button as the TV must first go through a power down cycle.

Attempts to address this issue have resulted in providing the consumer with two modes of operation in the off-state including a low power or conventional shut down mode and a fast power on mode. However, because the fast power on mode keeps many of the standard operating process running, it typically consumes a significant amount of power.

Therefore, it would be desirable to provide systems and methods that facilitate a fast transition from an off/low power or standby state to on/powered up operating state.

### SUMMARY

Embodiments described herein are directed to improved methods, systems and apparatus for providing a fast transition from a reduced power state, i.e., “standby”, to a powered up/operating state. In a preferred embodiment of a television comprising a fast power up system, the television includes programmable logic depicted preferably in the form of a control module. The control module is coupled to the television's on screen display (OSD) controller, which is also coupled to the television's display engine, which is optically coupled to the screen. The control module preferably includes one or more processors or CPUs managing the user interface and control of the television hardware.

In recent developments, certain CPUs or integrated System On Chips, such as AMD's Xilleon™ process chip, now include an alternate state or mode of operation that utilizes significantly less power while still retaining critical data in the RAM memory of the television. The television advantageously takes advantage of the CPU's low power mode of operation when the television is in a “standby” mode by maintaining the software itself and current data in RAM memory of the television. As a result, the television powers up faster and enables faster program viewing from “standby” state/mode than if operating in standard power-off mode. In the “standby” mode, the television start up and system check processes are significantly reduced as the CPU maintains standard mode operating parameters. To further reduce power, a separate simpler and very power efficient CPU can be used to control the switching on/off of power of the main CPU. This simpler CPU can be responsible for detecting remote controller commands, front key presses and other events while the main CPU is turned off in standby mode.

In operation, the system is either setup with the “standby” mode or the “low power” mode as the default mode of operation, or the user is provided the option of turning off the television by either selecting the “standby” mode, where the main CPU is not inactivated, or the “low power” mode, i.e., presented as “power off” to the user, where the main CPU is inactivated. If a standby mode is selected, a visual indicator, such as a different color LED, is preferably provided to let the consumer know the television is operating in a standby mode.

The process of starting up a television includes various steps of powering up individual components. When the television is in low power mode with the main CPU turned off or inactivated, the powering up and loading of software in the main CPU will add to the delay in the start-up process of the television. By using a simpler CPU to interpret the intended user mode of power on and in parallel powering up the display engine, the television can greatly reduce the startup time in either mode.

Since the main CPU startup time can exceed the time it takes to startup the display engine it can further enhance the experience if the low power CPU or main CPU (before it's fully started) provides an input signal for the display during the startup. By providing a basic graphics engine that is available during the startup, such display can be in the form of an hourglass, company logo or a horizontally opening curtain that depicts the effect of a cinema curtain, which provides a quick indication to the user that the television is in the process of starting up after the POWER key/button has been pressed by the user.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 depicts a schematic of a television control system.

FIG. 2 depicts a flow chart illustrating a preferred embodiment of a fast power up process.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

The systems and methods described herein provide for a fast transition from a reduced power state, i.e., “standby”, to a powered up/operating state in televisions. More particularly, in a preferred embodiment, the main processor or CPU of the control system of the television preferably includes an alternate state or reduced power consumption mode of operation now available in certain processor or CPU chips such as AMD's Xilleon™ processor chip. In the standby state or mode, the CPU preferably maintains the television's standard mode operating parameters to significantly reduce the television start up and system check processes upon power up or re-start of the television. In a low power mode of operation presented to the user as a “power off” or a “shut down” mode, the main CPU is preferably completely shut off or inactivated, and a very limited power consumption CPU or ASIC provides the logic needed for receiving IR codes, detecting the front power key and controlling the power of the main CPU and display engine.

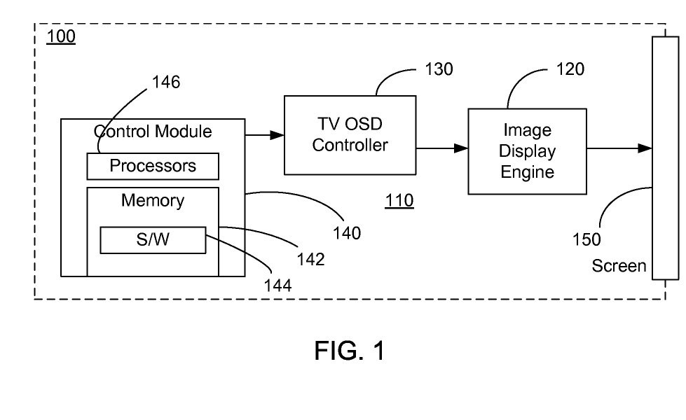

Turning in detail to the figures, FIG. 1 depicts a television 100 with a control system 110 for providing a fast power up mode of operation. The control system 110 includes programmable logic depicted as a control module 140. The control module 140 is coupled to the television on screen display (OSD) controller 130. The OSD controller 130 is coupled to the television projection or image display engine 120, which is operably coupled to the display screen 150.

The control module 140 preferably includes one or more processors or CPUs such as a simple CPU to manage a low power mode of operation and a main CPU with a reduced power consumption mode, preferably a system on a chip processor such as the AMD Xilleon™ processor chip, depicted as processors 146, non-volatile memory 142 and control system software 144 stored in the memory 142. The control system software 144 includes a set of instructions used to shut-down, start-up and control the operation of the television. The simple CPU or ASIC is preferably optimized to absolute minimum power consumption.

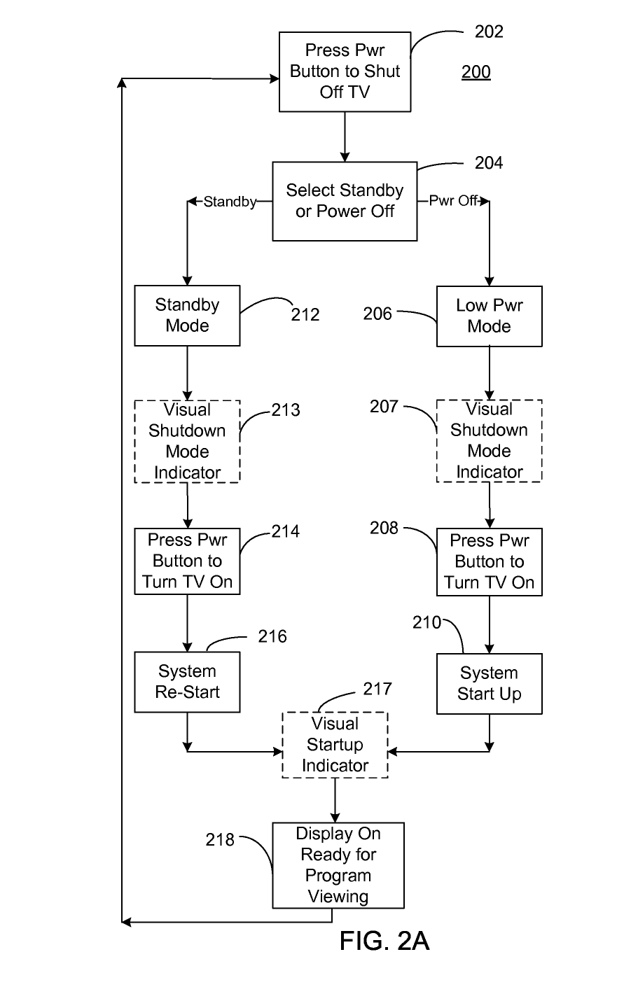

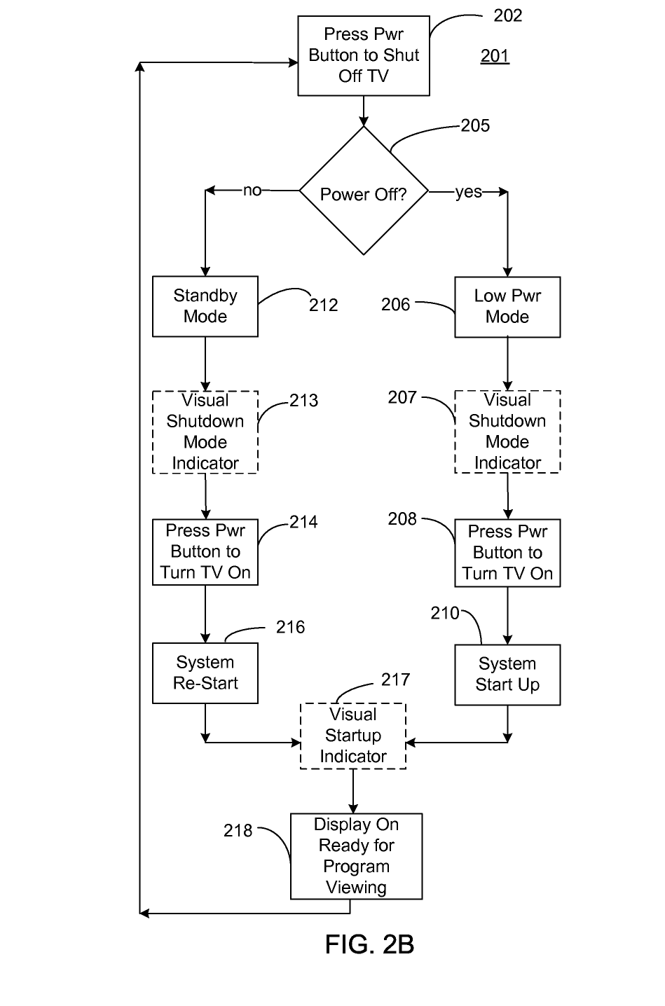

In operation, as depicted in the process flow diagram of the shut-down/start-up process 200 shown in FIG. 2A, when the user depresses the power button on a remote control unit or a control panel of the television 100 at step 202, the control system 110 prompts the user at step 204 to select a preferred “TV OFF” mode from the options of “Standby” or “Power Off”. If the user selects “Power Off”, the control system 110 at step 206 will shut the television 100 down to a near zero power state, i.e., the “low power” mode. In the low power mode, the television 100 draws minimal power. When the user presses the power button at step 208 the control system 110 starts the television 100 up at step 210 while proceeding through a variety of system checks and, when ready, turns the display screen 150 on ready for viewing at step 218.

If at step 204 the user selects “Standby”, the control system 110 at step 212 will shut the television 100 down to a slightly higher power state than the low power mode, i.e., the standby mode. In the standby mode, the television 100 takes advantage of the reduced power consumption mode of operation of the main CPU of the processors 146 wherein the main CPU maintains standard mode operating parameters while drawing a slightly higher amount of power than a television in low power mode. When the user presses the power button at step 214 the control system 110 re-starts the television 100 at step 216 by-passing much of the system checks and other start-up processes and, when ready, turns the display screen 150 on ready for viewing at step 218.

Alternatively, the control system 110 of the television 100 can be configured through a menu system set-up process with either the low power mode or the standby mode as the default mode of operation.

In a further alternative, as shown in FIG. 2B, the control system 110 is set with the standby mode, i.e., the fast power up mode, as the default mode of operation in the shut-down/start-up process 201. More particularly, when the user presses the power button at step 202, the user is asked whether they would like to proceed by fully shutting down or fully powering off the television 100. If the user answers “yes”, the control system 110 follows the low power mode shut down and start up process discussed above with regard to steps 206, 208 and 210. If the user answers “no”, the control system 110 follows the standby mode shut down and re-start process discussed above with regard to steps 212, 214 and 216.

As indicated above, in the standby mode the control module 140 or, more specifically, the main CPU of the processors 146 of the control module 140, is not fully powered down and remains in a reduced power consumption state. Some power consumption is needed to maintain RAM and other components. The power consumption of the television 100 when operating in the standby mode advantageously meets the EnergyStar™ system off power consumption requirements. By contrast, in the low power mode, the control module 140 is effectively turned off and only thing powered on is the simple or low power CPU of the processors 146 of the control module 140.

By using the simple or low power micro processor or CPU to do more than just detecting the power command, a more optimized boot can be achieved while in both the lower and standby modes of operation. More particularly, a circuit consisting of a simple CPU or alternatively some optimized PLD/ASIC that can capture IR codes is used to start up the display engine 120 while the main CPU goes through system checks and other start up processes.

The start-up process while in “standby” mode preferably proceed as follows:

1. User presses POWER

2. The low power CPU receives the POWER command.

3. The low power CPU knows the TV is in off mode and powers up the display engine immediately.

4. The low power CPU sends a RESUME command to the main CPU.

5. The low power CPU, optionally, outputs an hourglass or similar on the display engine.

6. The main CPU enables the settings necessary to show video and does not have to wait as long for the display engine to be ready as it was started earlier by the low power CPU and, thus, was starting up in parallel to enable a faster startup.

The start-up process while in “low power” mode preferably proceed as follows:

1. User press POWER

2. The low power CPU receives the POWER command.

3. The low power CPU knows the TV is in off mode and powers up the display engine immediately.

4. The low power CPU turns on power to the main CPU and the main CPU proceeds with system checks and other startup processes.

5. The low power CPU, optionally, outputs an hourglass or similar on the display engine.

6. When the main CPU is ready the low power CPU sends a START UP command to the main CPU.

7. The main CPU enables the settings necessary to show video and does not have to wait as long for the display engine to be ready as it was started earlier by the low power CPU and, thus, was starting up in parallel to enable a faster startup.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A control and image display system for a television comprising
a screen,
a image display system coupled to the screen,
an on-screen-display (OSD) controller coupled to the display system and the screen, and
a control module coupled to the OSD controller, the control module comprising a main processor configured with a reduced power mode of operation and adapted to maintain the television operating parameters while in the reduced power mode of operation.

2. The system of claim 1 wherein the control module further comprises a low power processor.

3. The system of claim 2 wherein the control module includes first and second shutdown modes wherein the main processor is maintained in its reduced power mode in the first shutdown mode and wherein power to the main processor is turned off in the second shutdown mode while the low processor remains active.

4. The system of claim 3 wherein the control module includes a control system configured to prompt a user to select between the first and second shutdown modes.

5. The system of claim 3 wherein the low power processor is configured to send instructions to resume operation to the main processor upon system power in the first shutdown mode and turn power on to main processor upon system power in the second shutdown mode.

6. A television shut down process comprising the steps of
entering a reduced power mode shutdown, wherein the television includes the reduced power mode shutdown and a low power mode shutdown,
maintaining system parameters while in a reduced power mode shutdown, and
displaying visual indicator denoting system is in reduced power mode shutdown.

7. The process of claim 6 further comprising the steps of
receiving instructions to shut down, and
prompting user to select between the reduced power shut down mode and the low power mode.

8. The process of claim 7 further comprising the steps of
receiving instructions to start up, and
instructing a main processor to resume operations, the main processor having a reduced power mode of operation wherein system operating parameters are maintained.

9. The process of claim 8 wherein the step of instructing the main processor to resume operations includes sending the resume instructions from a low power processor.

10. The process of claim 9 further comprising the step of the low power processor powering up an image display engine.

11. A television shutdown process comprising the steps of
entering a low power mode shutdown, wherein the television includes a reduced power mode shutdown and the low power mode shutdown,
maintaining system operating parameters while in a reduced power mode shutdown, and
displaying visual indicator denoting system is in reduced power mode shutdown.

12. The process of claim 11 further comprising the steps of
receiving instructions to shut down, and
prompting user to select between the reduced power shut down mode and the low power mode.

13. The process of claim 12 further comprising the steps of
receiving instructions to start up,
turning on power to a main processor using a low power processor, the main processor having a reduced power mode of operation wherein system operating parameters are maintained,
performing startup system checks, and
instructing a main processor to begin operations.

14. The process of claim 13 wherein the step of instructing the main processor to begin operations includes sending the begin instructions from the low power processor.

15. The process of claim 14 further comprising the step of the low power processor powering up an image display engine.
